(19) United States
(12) Patent Application Publication
(10) Pub. No.: US 2009/0285207 A1
(43) Pub. Date: Nov. 19, 2009

(54) SYSTEM AND METHOD FOR ROUTING PACKETS USING TAGS

(76) Inventors: Yochai COHEN, Har-Adar (IL); Michael Chaim Schnarch, Neve-Savion (IL); Uri C. Weiser, Atlit (IL)

Correspondence Address: Pearl Cohen Zedek Latzer, LLP, 1500 Broadway, 12th Floor, New York, NY, 10036, US

(21) Appl. No.: 12/120,656

(22) Filed: May 15, 2008

(51) Int. Cl. H04L 12/56

(52) U.S. Cl. 370/389

(57) ABSTRACT

A system and method for controlling traffic in a packet-based communication system is disclosed. A number indicative of the source of a request packet may be modified to receive a shifted source number which may be, according to embodiments of the invention, in an unused shifted range of source numbers. A destination number in a received packet may be extracted and if it is in the shifted range of port numbers that packet may be determined as a response packet, the shifted port number may be un-shifted back and its restored value may be used to direct that packet to the device which issued the request, substantially without having to extract any additional information from the packet.

### BACKGROUND OF THE INVENTION

Data centers today typically contain numerous servers that communicate with each other via requests and responses. The responses to requests sent by application threads will usually not reach the requesting thread's core, but rather some other core. The result is cache thrashing, branch target predictor thrashing, memory prefetch predictor thrashing, Translation Lookaside Buffer thrashing, decreased computing platform performance, and creating of an equally mediocre quality of service for all. Additionally, even within a single server platform there may be numerous entities, such as CPUs, memories, input/output (I/O) devices, etc., that typically communicate with each other, and within that platform, responses are not always being returned to the requesting or appropriate entity. Instead they may reach, on their way to the requesting or appropriate entity, a different entity, needlessly disrupting it before finally being routed to the correct entity.

### SUMMARY OF THE INVENTION

In a packet-based communication system, a packet comprising a request may be marked, according to embodiments of the present invention, so that when a corresponding response is received it may already include an indication that it is a response packet, and an indication of the entity in said communication system that it should be directed to. On its way from an active device in, for example, a computer platform, a request packet may be modified in, for example, an input/output unit of the computer platform. A field of the request packet indicative of the entity which initiated the request packet, herein after Source-ID, such as the field representing the source port number of the request packet, may be extracted and its value may be changed or shifted to be included in a different range of Source-ID numbers, for example in an unused range of Source-ID numbers. The shifting may be done using a simple algebraic calculation, such as simple addition of a constant, a conversion table, or similar methods. Once the Source-ID number is shifted the cyclic redundancy check (CRC) (or any equivalent checksum-like mechanism) of the packet may be re-calculated and the packet may be sent over the communication system. A packet in which a Source-ID number has been shifted or modified will be called hereinafter a tagged packet. An input/output unit may also receive packets sent over the communication system. The Destination-ID field of a received packet may be extracted and its relation to a range of Source-ID numbers may be verified. In many common protocols, the Destination-ID field of a response packet is copied from the Source-ID field of the corresponding request packet. If the field representing the Destination-ID number is found to be in a shifted range of Source-ID numbers that packet may be identified as a response packet. Then the value of the Destination-ID field number may be un-shifted, or restored, thus indicating both the original Source-ID number and the active device which issued the corresponding request. Based on that indication that packet may easily and efficiently be directed to the right entity of the right active device, without having to extract any other part of the packet for this purpose.

### BRIEF DESCRIPTION OF THE DRAWINGS

The subject matter disclosed in this application is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a schematic block diagram illustration of a system according to embodiments of the present invention;

FIG. 2 is a schematic communication diagram according to embodiments of the present invention; and

FIGS. 3A and 3B are schematic flow diagrams of operation of system according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

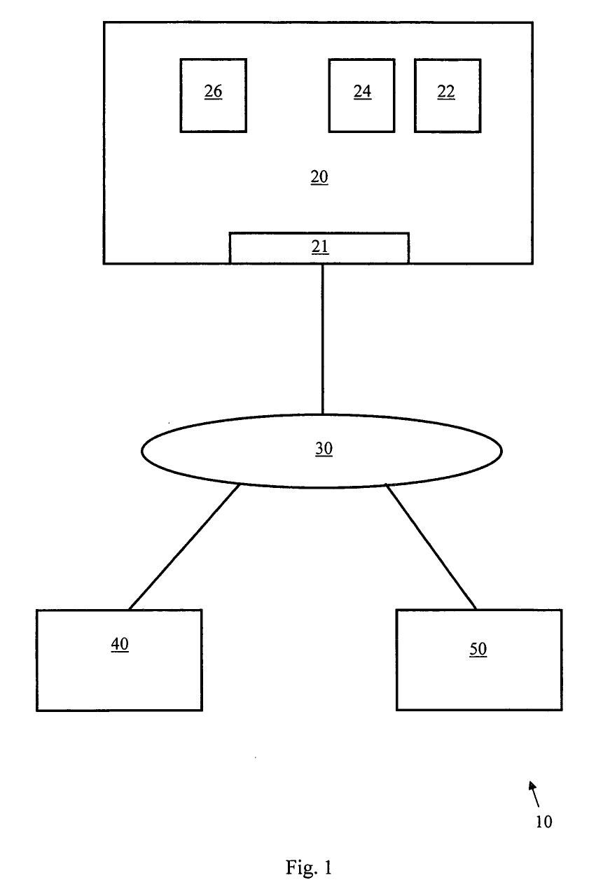

Reference is made now to FIG. 1, which is a schematic block diagram illustration of system 10 according to embodiments of the present invention. System 10 may comprise a plurality of computing entities such as computer platform 20 and one or more remote units 40 and 50 connected to each other via communication system 30. In this application the term ‘computing entity’ may refer to computer central processing unit (CPU), computer memory such as random access memory (RAM) and the like, CPU cache memory or the like, an I/O device such as a disk controller, a networking device such as a Network Interface Card (NIC), Host Bus Adapter (HBA), or an auxiliary processing or computing device or chip, such as a Graphics Processor (GPU), Encryption/Decryption processor, Compression/Decompression/Encoding/Decoding/Detection processor, application-specific Field Programmable Gate Array (FPGA) or Application Specific Integrated Circuit (ASIC), etc. Computing platform 20 may comprise several active units such as first CPU 22 and second CPU 24, optionally at least one additional unit, such as memory unit 26 and communication interface unit 21. Communication system 30 may be any system which enables the connection of two or more computing entities and supports packet-based protocols such as Ethernet, transmission control protocol (TCP), user datagram protocol (UDP), stream control transmission protocol (SCTP), datagram congestion control protocol (DCCP), internet control message protocol over internet protocol (ICMP/IP) or any other network protocol which supports communication control involving indication of the unit or address initiating the communication and the destination unit or destination address. In other embodiments of the present invention system 10 may represent an on-board computing system with a computing platform 20 and two or more peripheral units 40 and 50 and communication system 30 may be an internal communication arrangement, such as a bus or a collection of point-to-point links, supporting connections between on-board units 22, 24, 26 and peripheral units 40 and 50 needing to communicate with each other. Herein after in the description of embodiments of the present invention the term ‘active entity’ may refer to units and functionalities such as CPU, storage apparatus, I/O device and other bus devices, which may send a request to another entity via a communication system or channel and expect a response from that other entity. Peripheral units 40 and 50 may be active entities located remotely from a given active entity, such as additional CPU, additional memory, a storage apparatus and the like.

As part of the operation of one or more applications in computer platform 20 two or more of first CPU 22 and second CPU 24 may send requests to remote active entities, such as remote units 40 and 50, via communication system 30. Handling of sending of a request from any of first CPU 22 or second CPU 24 may be handled by interface unit 21. In some embodiments interface unit 21 may handle also the receiving of a response to a request sent, for example, by first CPU 22 or second CPU 24. Interface 21 may be a network interface card (NIC), a software interface driver, combination of the first and the latter and the like.

A request which is sent from an active entity such as first CPU 22 or second CPU 24 may be formed as one or more packets. Each packet may include a portion, such as a field comprised of bits (bitfield) or a collection of bitfields, which identifies the sender of the packet, such as the port, the address, the logical unit number, etc. from which the packet is sent. The source identification, or the Source-ID, may be used to direct a response for the request back to the sender of the request. Typically, source identification using bitfields such as source port number or source address for a given protocol, may be allocated from a large pool and typically have no particular function other than identifying the sending process and the connection itself, by its number. Therefore, a specified numerical range of source identifier (Source-ID) numbers may be defined for use by certain active entities. Such specified numerical range of source identifier numbers, such as source port numbers or source address numbers, being a first range of port numbers, may be partial to a larger range of numbers which are valid for the communication protocol or system in use. A portion of the valid range of source identifier numbers may be a shifted range of numbers, being a second range of source identifier numbers. The shifted range of Source-ID numbers may be unused in certain configurations. According to embodiments of the present invention, a packet which is part of a request sent by an active entity over communication system 30 may be modified, or tagged, so that the source identifier number, such as the source port number or source address, is modified before the packet enters communication system 30. The modification of source identifier may be, according to embodiments of the invention, by shifting the source identifier number, being in the first range of Source-ID numbers, into the unused shifted range of identifier numbers, to generate a shifted source identifier number such as a shifted source port number or shifted address, to be allocated from the second range of numbers in a manner that the shifted source identifier number is a unique presentation of the original source identifier number in the second, shifted range of numbers. For example, in system 10 a constant rule of shifting of source port numbers may be applied so that each source port number of the first range of ports numbers may constantly be shifted to a certain second, shifted, range of port numbers located in the unused range of source port numbers by, for example, a constant value of shift, using, for example, algebraic “add” or “subtract” operation. Thus, according to embodiments of the present invention, each source port number may have a unique shifted port number residing in the second range of Source-ID numbers and associated uniquely with the source port number.

According to some embodiments of the invention shifting of a source identifier such as a source port number into a second range of port numbers, such as, for example, an unused range of source port numbers, may be done using any other algebraic, logical, conversion table or other shifting method which may uniquely map a source identifier number from the first range of identifier numbers to a source identifier number in the second, shifted, range of identifier numbers. Shifting of a source identifier number into a second range of source identifier numbers, such as, for example, the unused range of source numbers, may be carried out, for example, by interface unit 21. Interface unit 21 may carry out the process of shifting the source port number in software only, in hardware only or using combination of hardware and software. Accordingly, interface unit 21 may be modified by modifying relevant portions of its software package, such as an input/output (I/O) device driver and/or at the networking stack and/or by modifying its hardware. Typically modification of the relevant software may be very easy to perform. Shifting of a port number to a shifted range may be done according to one or more of many different rules. For example, shifting of a source port number into a shifted range of numbers may be done simply by adding a fixed value to the source port number. However, many other rules and functions may be used to map a source port number uniquely into a shifted range of numbers.

Such rules or methods of shifting a source identifier number may also be used, according to embodiments of the present invention, for tagging a request packet with more than one type of information for example by encoding into the shifted identifier number additional information which may carry additional instructions or directions for handling a respective forthcoming response packet. For example, a portion of the shifted identifier number, such as the four least significant bits of the shifted identifier number, may be used to indicate to which CPU the response packet should be delivered, for example CPU 22 or CPU 24. Upon receipt of a response packet, after interface unit 21 delivers the packet to the proper CPU by inspecting the four least significant bits in the relevant portion of the packet, it may further consult a table and figure out the value of the original identifier such as the original source port number, restore the Destination-ID number to its original (unshifted) value, and deliver the packet for further processing as is typically done with most other packets. In some embodiments the calculation to determine the requesting CPU may be done in hardware and the calculation of the original requesting source identifier may be done in software, for example in a driver. The decision, during request packet handling, which CPU to designate for processing the forthcoming response packet may be taken for example so as to balance the loads between multiple CPUs, to prefer one CPU over another based on its specific features and/or specific attributes of the request, and the like. Yet, it will be apparent that other configurations may fall under the scope of embodiments of the invention. Alternatively, the shifted identifier number may simply be an index to a table within the interface unit, which will contain the relevant information as described above. Thus, according to embodiments of the present invention, interface unit 21 may perform the source number shifting task, as part of the handling of a packet which is about to be sent over communications system 30.

Shifting of a source identifier number into a shifted range of numbers and returning the shifted identifier number to its original value of the source identifier number (also called hereinafter tagging/untagging) of the request and response packets, respectively, may be carried out in hardware. In such case the tagging/untagging may be carried out anywhere in the hardware portions of a transmit/receive path of a computer platform. Tagging/untagging can also be carried out in a computer's chipset (not shown). The result of the tagging operation, that is the value representing the shifted source identifier number, such as the source port number or source address, remains unchanged as the request packet travels to the entity that will handle the request and further, as a respective response packet travels back in communications system 30. Interface 21 may be modified to identify an incoming packet as a response packet, for example, merely by extracting its relevant identifier number such as its destination port number or destination address. Any incoming packet having an identifier number in the second, shifted range of numbers, may be interpreted as a response packet. Interface 21 may further be adapted to modify a response packet so as to untag it by changing the value of the shifted identifier number back to its original respective source identifier number of the original request packet. It will be apparent that tagging a source identifier number and/or untagging a shifted identifier number is typically a simple operation requiring very little computation resources and may be carried out very quickly. As explained above with respect to the tagging operation, untagging may be carried out in hardware, in software, in a combination of hardware and software and the like.

According to some embodiments of the present invention, carrying out the tagging and/or untagging process in software and the routing of the response packet(s) in hardware using information extracted from the tag, such as the original source identifier number and the identity of the active entity expecting the response, may present benefits such as high efficiency, avoidance of sending the response to an incorrect entity only to be subsequently rerouted to the right entity, high throughput, low latency and/or improved quality of service figures. If the remote active entity is a disk, shifting the direct memory access (DMA) addresses to an unused shifted range can take place in hardware or software, with expected similar benefits. Untagging of response packet(s) will probably take place in hardware so that the disk response gets written to the correct memory address in the correct requesting active entity.

According to embodiments of the present invention shifting (or tagging) may be done by consulting a table, determining what should be the shifted source identifier number (or shifted address), writing the modified value to the packet in the command header (for network/disk, respectively), and recalculating checksum or cyclic redundancy check (CRC) for the packet/command. Accordingly, untagging of response packet may be done in the same manner, that is, the shifted identifier number may be shifted back to its original value and then CRC value (or any other authentication mechanism) may be recalculated. The correctness of the identifier number may further be secured by checking before tagging/untagging that the port number (or DMA address for disk I/O) is within a predefined and pre-allocated port range (or address range for disk I/O).

When a packet is sent over a communication system, as mentioned above, before the tagging process is applied for a specific connection (using the TCP protocol) or for an initial UDP protocol request, system 10 should verify that the packet has been initiated from computer 20 (i.e. is a request) and is not a response to a previous request. In TCP this may be done by checking for the presence of the synchronize sequence numbers (SYN) bit together with the absence of the acknowledgement number (ACK) bit. In UDP this may be done by monitoring all UDP traffic and marking in a table all incoming unsolicited (i.e. incoming requests, not responses) UDP packets. This way system 10 may distinguish between outgoing packets that are mere responses to UDP requests directed at this computer (and thus should not be modified) and outgoing packets that are genuine requests and thus should be tagged. In cases where HW resources are limited, it may be advisable to place the above mentioned tables in SW, yet, checking whether a port number is within a specific range may be carried out in HW, as it may be accomplished using, for example, a couple of comparators, thus present high efficiency of resource usage.

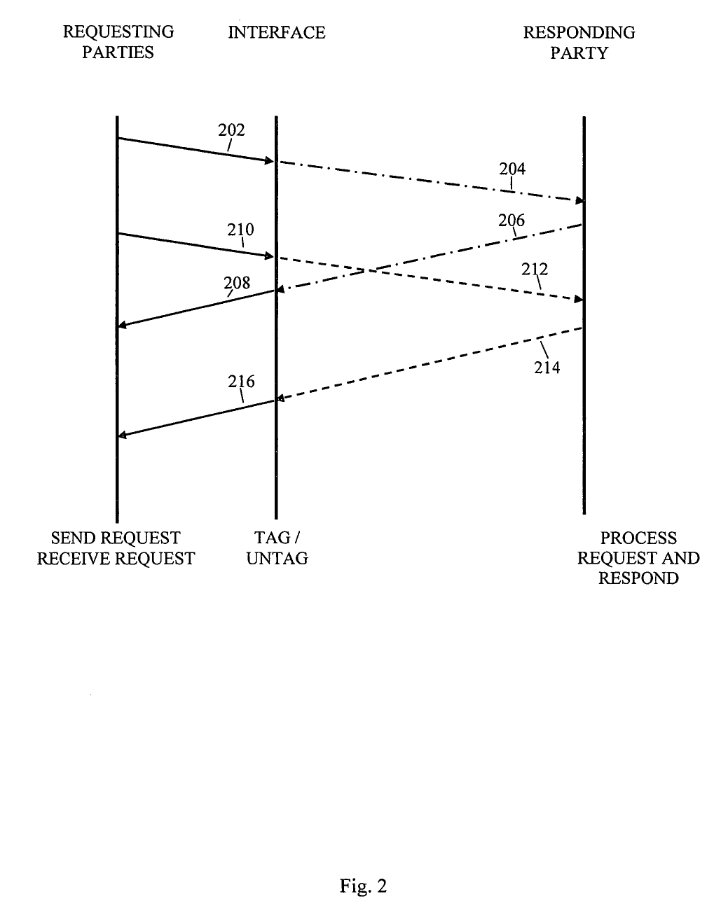

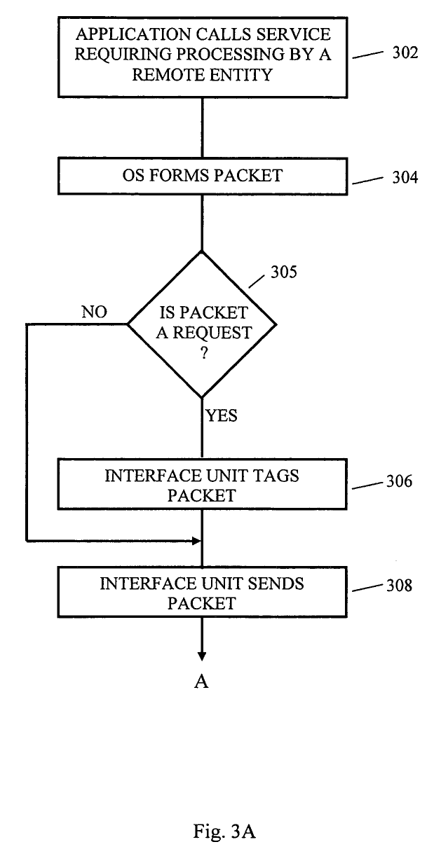

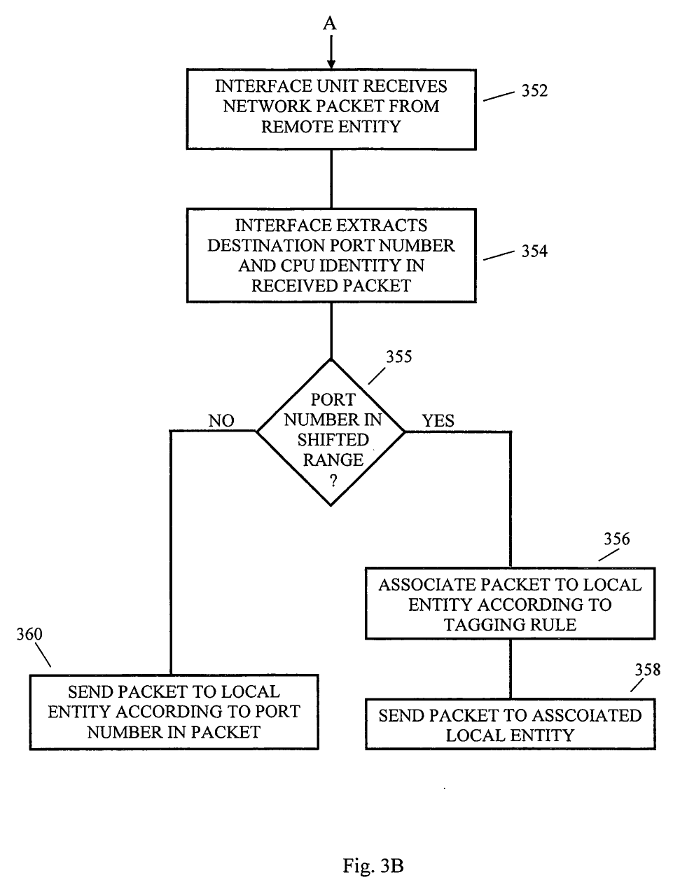

Reference is made now to FIGS. 2, 3A and 3B which are a schematic communication diagram and schematic flow diagrams of operation of system 10, respectively, according to embodiments of the present invention. An application running on one or more active entities may require response from a remote active entity (block 302). An operating system (OS), for example, may form one or more packets containing the request (block 304). The active entity, such as CPU 22 or CPU 24, may send the packet to interface unit 21 (steps 202, 210). Interface unit 21 may verify whether the packet is part of a request message (decision point 305). In case the packet is part of a request message interface unit 21 may tag the packet as a ‘request packet’ by shifting the value of its source port number according to an applicable rule of source port shifting, to a shifted source port number (block 306). Packets which are not part of a request message will not be tagged. Tagged and untagged packets may then be sent to their destination via communication network 30 (block 308). Packets which were verified as part of request message travel through communication network 30 towards their respective remote active entity destinations, such as remote active units 40, 50 (steps 204, 212) with shifted source port numbers.

Each packet forming part of a response to a request may be sent back, once processing of the request for this packet is done, via communication network 30 with its tag, that is its shifted source port number still ‘attached’ to it. The tag, the shifted source port number, may typically be located in the destination port field of the packet (steps 206, 214). Packets arriving at computer platform 20 may be handled by interface unit 21. Each packet received by interface unit 21 (block 352) may be extracted in order to get the value of its destination port number, indicating what was the source port number of the corresponding request packet (block 354). Interface unit 21 may then verify, at decision point 355, whether the received packet is part of a response message for a request message for which the source port number is in the shifted range of port numbers or whether it is some other kind of packet. In case the packet is part of a response message interface unit 21 may associate its shifted port number to its original port number for example by applying the rule used for shifting the source port number in a reversed manner (block 356) and send this packet to the local active entity associated with the source port number (block 358). According to embodiments of the invention during the process of identifying the port number as shifted and accordingly unshifting the port number, extra information may be extracted from the port number and/or from associated tables. Such additional information enables making an improved decision regarding to which active entity that response should be sent and/or to which address within the active entity the response should be sent. If at decision point 355 the extracted port number is not in the shifted range of port numbers the relevant packet is sent to the active entity associated with the value of the port number extracted from it without any change (block 360) just as it would have been done without exercising any change to the value representing the source port number in a packet according to embodiments of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
receiving a request packet to be sent in a communication system, said packet comprising a source identifier number indicative of the sender of said packet, said number being in a first range of source identifier numbers;
changing the value of said source identifier number of said packet to a shifted identifier number value to create a shifted identifier number, said shifted identifier number is in a shifted range of identifier numbers; and
sending said packet with said shifted identifier number in said communication system to its destination.

2. The method of claim 1 wherein said shifted identifier number is a unique representation of said source identifier number in said shifted range of identifier numbers.

3. The method of claim 2 wherein said shifted identifier number is generated from at least said source identifier number using at least one of: shift by a fix value function, shift using a unique mathematical function and shift according to a table matching a single shifted value in said shifted range of identifier numbers to each of said source identifier numbers.

4. The method of claim 1, wherein said shifted range of identifier numbers is unused by any other function.

5. The method of claim 1, wherein said changing of said value of said source identifier number to be done in an interface unit of a computing platform.

6. The method of claim 1, wherein said changing of said value of said source identifier number to be done in at least one of software, hardware and combination thereof.

7. The method of claim 1 wherein said changing of said value of said source identifier number of said packet to a shifted identifier number further comprising recalculating of the cyclic redundancy check (CRC) of said packet.

8. A device comprising:
a computer platform having at least two central computing unit (CPU) and a communication interface unit to connect said computer platform to a communication system;
wherein said communication interface unit is adapted to change the value of a source identifier number of a request packet sent from one of said at least two central computing units (CPU) to a destination in a communication system to a shifted identifier number value, said shifted identifier number is in a shifted range of identifier numbers.

9. The device of claim 8, wherein said communication interface unit is further adapted to:
receive a packet from said communication system;
extract a destination identifier number from said packet;
verify if said identifier number is in a shifted range of identifier numbers, being a shifted identifier number; and
change the value of said shifted identifier number to an un-shifted identifier number.

10. The device of claim 9, wherein the said change of said value of said shifted port number to an un-shifted port number is done using at least one of: un-shift by a fix value function, un-shift using a unique mathematical function and un-shift according to a table matching a single shifted value in said shifted range of port numbers to each of said source port numbers.

11. The device of claim 9 further adapted to extract from said shifted port number at least an identity of a CPU to process said response packet.

12. The method of claim 3 wherein said shifted port number further comprises data indicative of a CPU to process a respective response packet.

13. A method comprising:
in an interface unit receiving a packet from a network;
extracting a destination port number from said packet;
verifying if said port number is in a shifted range of port numbers, being a shifted port number;
changing the value of said shifted port number to an un-shifted port number.

14. The method of claim 13, wherein said changing of said value of said shifted port number to an un-shifted port number is done using at least one of: un-shift by a fix value function, un-shift using a unique mathematical function and un-shift according to a table matching a single shifted value in said shifted range of port numbers to each of said source port numbers.

15. The method of claim 13, wherein said changing of said value of said port number to be done in at least one of software, hardware and combination thereof.

16. The method of claim 13, wherein said un-shifted port number is a unique representation of said shifted port number in an un-shifted range of port numbers.

17. The method of claim 13 wherein said changing of said value of said shifted port number of said packet to an un-shifted port number further comprising recalculating of the cyclic redundancy check (CRC) of said packet.
